(19) United States
(12) Patent Application Publication
(10) Pub. No.: US 2013/0182121 A1
(43) Pub. Date: Jul. 18, 2013

(54) MIRROR, CASING AND INFRARED DEVICE AND METHOD OF MANUFACTURING SAME

(71) Applicants: Juergen Huppertz, Freiburg (DE); Bedrich Hosticka, Muelheim an der Ruhr (DE); Daniel Wuerfel, Muelheim an der Ruhr (DE)

(72) Inventors: Juergen Huppertz, Freiburg (DE); Bedrich Hosticka, Muelheim an der Ruhr (DE); Daniel Wuerfel, Muelheim an der Ruhr (DE)

(21) Appl. No.: 12/599,031

(22) PCT Filed: May 8, 2007
(86) PCT No.: PCT/EP2007/004062

§ 371 Date: Mar. 5, 2010

(51) Int. Cl. G02B 5/10; H04N 5/33

(52) U.S. Cl. CPC G02B 5/10; H04N 5/33
USPC 348/164; 359/350; 359/871; 359/855; 264/1.1; 264/1.7; 156/245

(57) ABSTRACT

A mirror comprises a doubly curved surface and is formed by pressing or casting. Additionally, a casing comprises a mirror including a doubly curved surface and formed by pressing or casting. An infrared device includes an infrared sensor or an infrared source and a mirror having a doubly curved surface formed by pressing or casting.

### CROSS-REFERENCE TO RELATED APPLICATIONS

This application is a national phase entry of PCT Patent Application Serial No. PCT/EP2007/004062, filed 8 May 2007, and is incorporated herein in its entirety by reference.

### DESCRIPTION

The present invention relates to a mirror, a casing and an infrared device and to a method of manufacturing the mirror and a method of manufacturing a casing comprising such a mirror.

Infrared or thermal image cameras are increasingly used like, for example, for localizing heat insulation leaks in a building. Lenses made of special materials are employed in the optics for infrared or thermal image cameras, since glasses for the visible range of light absorb long-wavelength infrared radiation. Zinc-selenium, germanium or silicon compounds are frequently used when, for example, manufacturing infrared optics for wavelengths from 8 μM to 14 μm.

Recently, special glasses made on the basis of germanium, like Amtir® or Gasir®, are employed when manufacturing the optics for infrared cameras. Due to the usage of these materials or glasses, the lenses can be pressed so that the production process is cheaper than when using zinc-selenium, germanium or silicon compounds, however, the basic materials required, like, for example, germanium, still are relatively expensive. Another way of reducing the manufacturing costs for infrared or thermal image cameras is employing reflective optics, like, for example, a mirror, in the infrared optics instead of refractive optics, like, for example, a lens. When using conventional mirrors for manufacturing infrared or thermal image cameras, no significant advantages as to costs result since mirror optics for such systems employed in the infrared range are produced by processing a surface by means of grinding or turning, diamonds being employed here as tools. These manufacturing processes are very expensive due to the tools necessary, so that the manufacturing costs for such mirrors and/or mirror optics are high.

It is the object of the present invention to provide a mirror, a casing comprising a mirror, and an infrared device which can be manufactured in a cost-effective way, and a method of manufacturing same.

This object is achieved by a mirror of claim 1, a casing of claim 9, an infrared device of claim 21, a method of claim 27 and a method of claim 29.

The present invention provides a mirror having a doubly curved surface formed by pressing or casting.

Furthermore, the present invention provides a casing comprising a mirror having a doubly curved surface formed by pressing or casting.

In addition, the present invention provides an infrared device comprising an infrared sensor or an infrared source and a mirror having a doubly curved surface formed by pressing or casting.

Additionally, the present invention provides a method of manufacturing a mirror having a doubly curved surface which includes pressing or casting a pressing or casting material into a mold.

Also, the present invention provides a method of manufacturing a casing comprising a mirror having a doubly curved surface formed inside the casing, the method including pressing or casting a pressing or casting material into a mold such that the doubly curved surface will form inside the casing.

The present invention is based on the realization that a mirror having a doubly curved surface, which is, for example, suitable for being used in an infrared system, may comprise a higher surface roughness than a conventional mirror, so that this mirror may be formed by pressing or casting. That is how the manufacturing costs for such mirrors can be reduced, thereby lowering the manufacturing costs for infrared or thermal image cameras.

It is of particular advantage in infrared systems or thermal image cameras which are frequently employed in wavelength ranges of 3 μm to 5 μm and/or 8 μm to 14 μm that surface precisions in a range of one eighth, or 12.5%, to one fourth, or 25%, of the respective wavelength are sufficient to produce imaging optics adequate for the field of application so that a mirror for such a usage in an infrared device can be pressed or cast in a cost-effective manner. A surface precision achieved when pressing or casting, which, for example, is in a range from 0.3 μm to 3 μm and/or at roughly 1 μm, is sufficient for a mirror employed in an infrared system so that such a mirror of considerably reduced manufacturing costs can be employed in an infrared device. The roughness or surface roughness indicates to which extent the shape of the surface is allowed to deviate from the ideal shape.

Such infrared systems are provided with optics comprising at least one mirror having a doubly curved surface. However, two or even more mirrors are arranged in embodiments of other infrared systems, since they allow an additional degree of freedom when constructing the optics, which is accompanied by an increased flexibility when designing the setup of the optics. At the same time, imaging characteristics can be improved by using several mirrors in an infrared system and/or casing which is, for example, used in an infrared system. Due to the fact that two or more mirrors are used in embodiments of infrared systems of this kind, the cost proportion of mirrors in such systems is increased. In infrared systems of this kind, the manufacturing costs may be reduced by forming the mirrors having the doubly curved surface by means of pressing or casting, wherein the cost reduction, in proportion, manifests itself to an even greater extent in the overall manufacturing costs. Thus, the manufacturing costs for such infrared systems may, proportionally, be reduced even more.

It is of further advantage that free-form areas may be used for rectifying or correcting higher-order imaging errors when forming the mirrors, wherein bodies having such free-form areas may be formed easily by pressing or casting and only manufacturing such a pressing mold or casting mold entails increased costs, whereas a plurality of suitably set-up mirrors having corresponding free-form areas may be manufactured by the pressing or casting molds produced in this way. Thus, the manufacturing costs for such infrared systems may be reduced to a particularly noticeable extent. This results from the fact that a conventional production of mirrors by means of turning or grinding is very complicated and expensive, whereas, when using a corresponding pressing or casting mold when producing, the manufacturing costs may be reduced such that they are equivalent to that of mirrors the shape of which can be described by a single curve, or singly curved mirrors.

Embodiments of the present invention will be detailed subsequently referring to the appended drawings, in which:

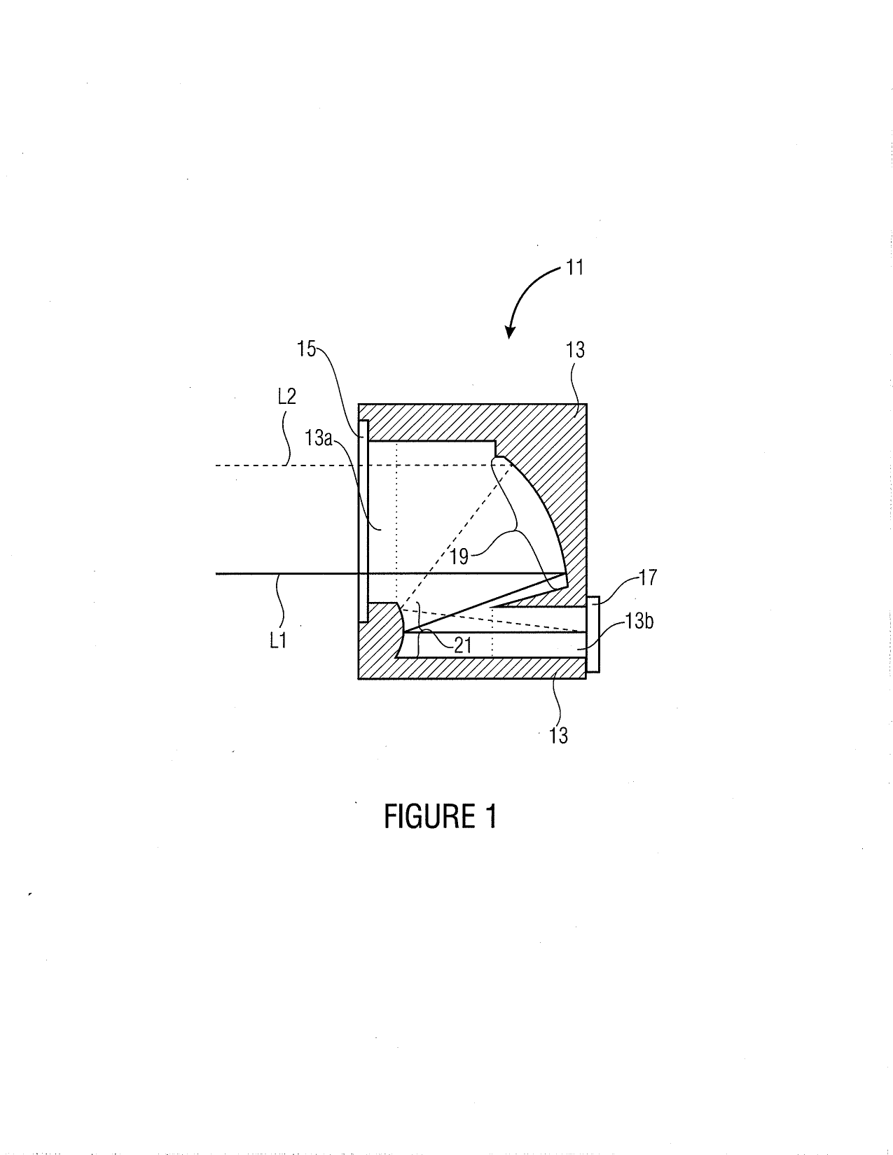

FIG. 1 shows a cross-sectional view of infrared optics in accordance with a first embodiment of the present invention;

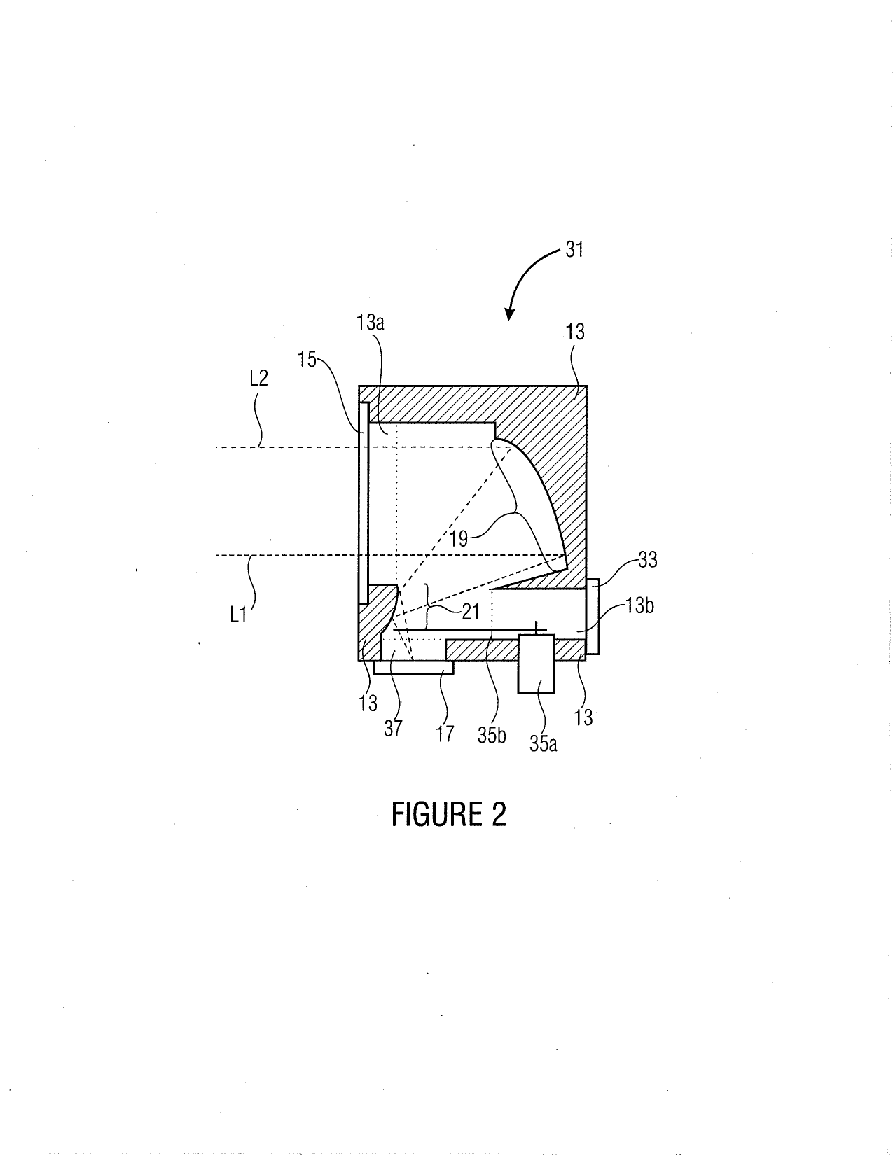

FIG. 2 shows a cross-sectional view of infrared optics in accordance with a second embodiment of the present invention;

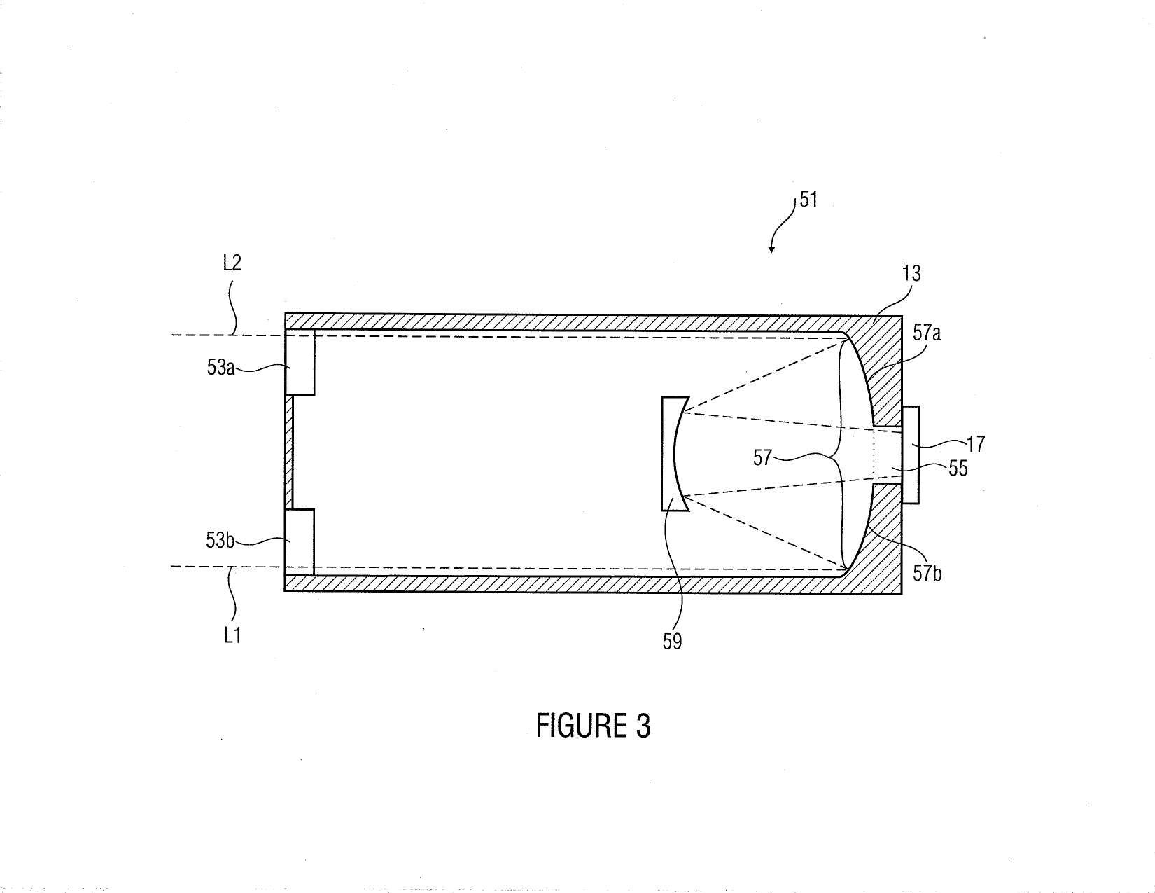

FIG. 3 shows a cross-sectional view of infrared optics in accordance with a third embodiment of the present invention;

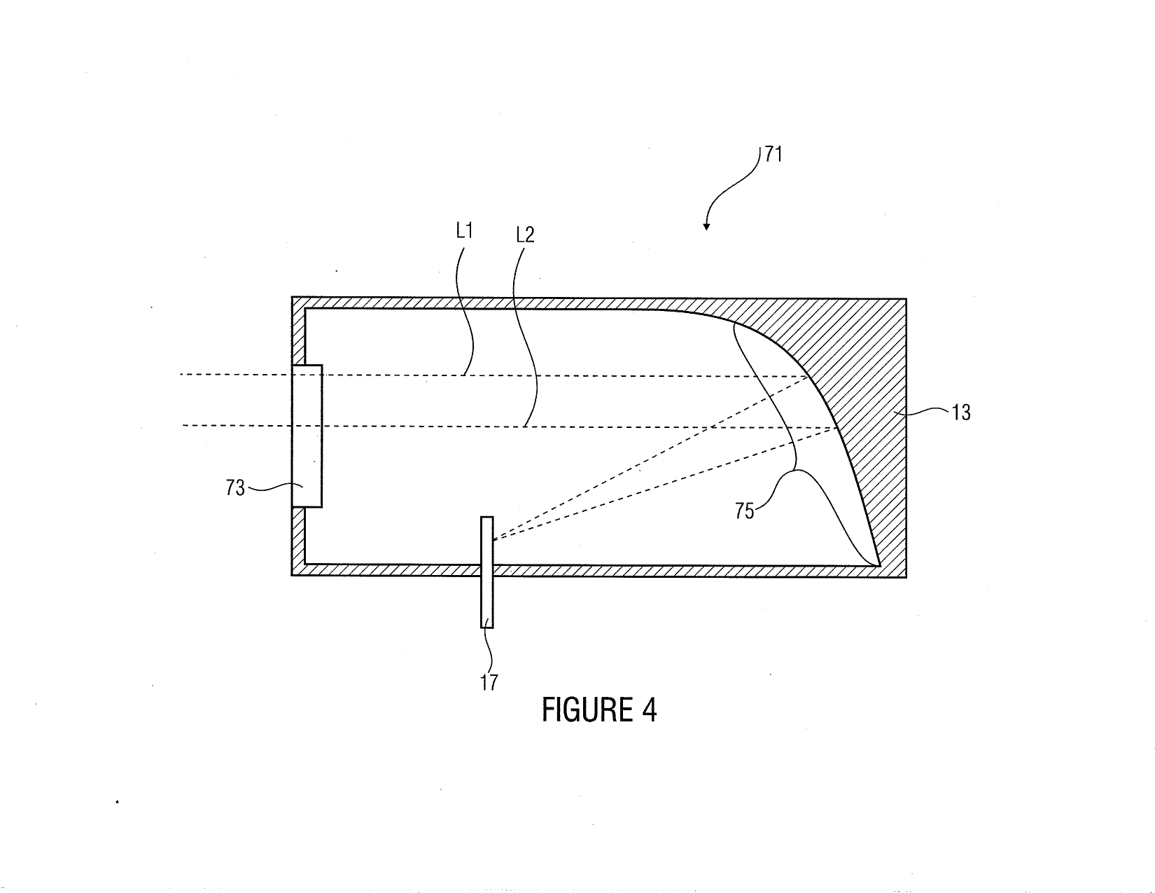

FIG. 4 shows a cross-sectional view of infrared optics in accordance with a fourth embodiment of the present invention; and

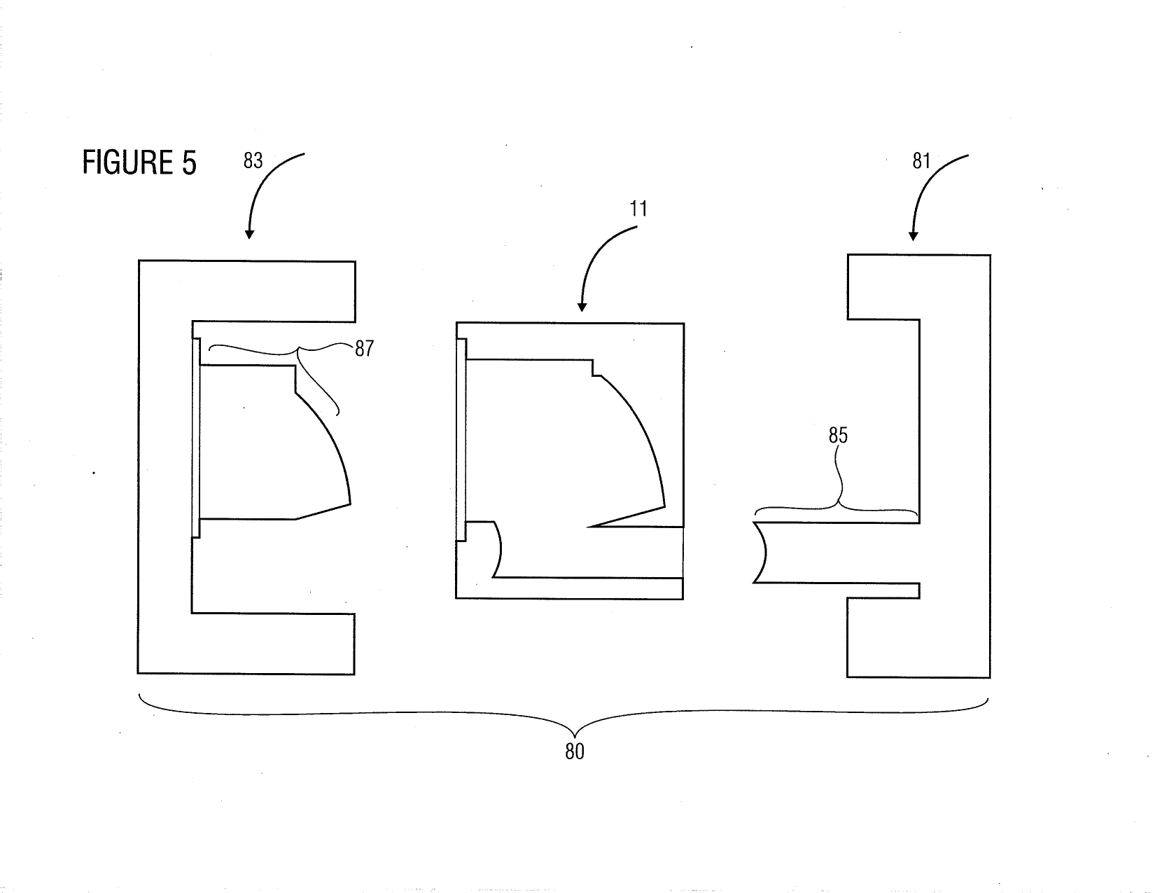

FIG. 5 shows a mold for manufacturing a casing for the infrared optics, and a setup of the infrared optics manufactured thereby.

FIG. 1 shows a cross-sectional view of infrared optics or an infrared device 11 in accordance with a first embodiment of the present invention. The infrared optics 11 are arranged in a casing 13, the first side wall of which comprises a recess at an opening 13a and the second side wall of which, opposite the first side wall, comprises a second opening 13b. A transparent lid 15 or lid 15 translucent for infrared radiation is mounted to the first side wall of the casing 13 over the first opening 13a, the lid 15 completely covering the opening 13a and sealing the interior of the casing 13. The lid 15 may also be embodied as a correction plate, like in a Schmidt telescope, the setup of which will be discussed in greater detail below. The lid 15 may also serve as a lens and may be embodied as a Fresnel lens.

Thus, the interior of the infrared optics 11 is protected from penetrating humidity or dirt particles, wherein penetrating humidity or dirt particles might impede the functionality of the infrared optics. An infrared sensor 17 is arranged on the second side wall in which the second opening 13b is formed, the infrared sensor 17 serving for detecting impinging infrared radiation or thermal radiation in its intensity or position.

A surface of the casing 13 facing the interior of the infrared optics 11 forms a first mirror 19 characterized by a doubly curved surface, the surface being curved relative to two mutually perpendicular axes. Furthermore, the surface of the casing 13 facing the interior of the infrared optics 11 is, in another region, characterized by a double curvature so that a second mirror 21 is formed in the other region of the surface. The double curvature of the surface or inner surface of the casing 13 in the region of the mirrors 19, 21 is also characterized by a curvature or linear curve relative to two mutually perpendicular axes.

An infrared ray L1 entering the interior of the casing through the transparent lid 15 or in the incidence region of the casing 13 impinges on and is deflected by the first mirror 19 such that, in its further course, it impinges on 21 and is deflected by the second mirror such that it reaches, in its further course, the infrared sensor 17. The infrared sensor 17 detects and captures the impinging first infrared ray L1. In addition, a second infrared ray L2 entering through the transparent lid 15 is deflected by the first mirror 19 and the second mirror 21 to the infrared sensor 17 such that the sensor 17 detects the second infrared ray L2, too.

The infrared optics 11 according to an embodiment of the present invention shown in FIG. 1 is thus able to project a thermal image of an infrared source, not shown here, arranged in front of the transparent lid 15 to the infrared sensor 17 by deflecting the infrared rays, which is discussed here exemplarily by means of diverting the first infrared ray L1 and the second infrared ray L2. Thus, an image of thermal radiation of a large-area infrared source can be produced on the sensor 17 which comprises a sensitive region of relatively small dimensions.

Of particular advantage in the infrared optics according to a first embodiment of the present invention is the fact that the mirrors 19, 21, in contrast to a telescope setup, which will be discussed in an embodiment of infrared optics below, are not opposite each other, so that the non-opposite mirror areas may be manufactured by casting or pressing a suitable material into a corresponding mold. Since the mirror areas are not opposite each other, simple molds may be used for realizing the double curvature of the surfaces. The mutually offset mirrors 19, 21 are also referred to as offset mirrors.

In addition, it is of particular advantage in the setup of the infrared optics 11 that the first mirror 19 is opposite the first opening 13a and the second mirror 21 is opposite the second opening 13b. Thus, the infrared optics 11 may be manufactured easily by pressing or casting a plastic material into a precast mold and by subsequently vapor-depositing a metal, like, for example, aluminum, onto a surface facing the interior of the casing through the first opening 13a or the second opening 13b, so that a reflective layer of the aluminum material will form on the surface of the casing in a region of the first mirror 19 and a region of the second mirror 21, respectively.

A cross-sectional view of further infrared optics 31 in accordance with a second embodiment of the present invention is discussed in FIG. 2. Subsequently, same elements or elements having the same effect compared to the infrared optics 11 in accordance with a first embodiment of the present invention shown in FIG. 1 will be provided with the same reference numerals. Furthermore, the description of the infrared optics in accordance with a second embodiment of the present invention shown in FIG. 2 is restricted to describing differences to the infrared optics in accordance with a first embodiment of the present invention shown in FIG. 1.

In contrast to the infrared optics 11 in accordance with a first embodiment of the present invention shown in FIG. 1, in the infrared optics 31a cover lid 33 is attached to the second side wall of the casing 13 such that it covers the second opening 13b. In addition, a recess in which a shutter 35a is arranged is formed in a wall of the casing 13. A surface or outer face of the third side wall is arranged to be perpendicular to the surface of the first side wall of the casing or the surface of the second side wall of the casing. An aperture 35b the position of which can be changed by the shutter 35a such that the aperture 35b covers or exposes a portion of a third opening 37 in the casing 13 which extends from the interior of the casing to the surface of the third side wall, is attached to the shutter 35a. The infrared sensor 17 is attached to the third side wall such that the sensor 17 completely covers the third opening 37 in the casing 13.

In contrast to the infrared optics 11 in accordance with a first embodiment of the present invention shown in FIG. 1, in the infrared optics 31 in accordance with a second embodiment of the present invention, the second mirror 21 is modified or altered such that it deflects the incident infrared rays L1, L2 onto the infrared sensor 17 arranged at the third opening 37. In contrast to the infrared optics 11 shown in FIG. 1, additionally, the infrared optics 31 in accordance with a second embodiment of the present invention is characterized by a folded optical path resulting from a modified surface shape of the second mirror 21 in the infrared optics 31 in accordance with a second embodiment of the present invention. The internal face of the casing or surface of the second mirror 21 is thus shaped such that the infrared rays L1, L2 are not deflected to the second opening 13b, but the third opening 37.

FIG. 3, too, shows a cross-sectional view of infrared optics, but of infrared optics 51 in accordance with a third embodiment of the present invention. Same reference numerals or reference numerals having the same effect compared to the optics 11 in accordance with a first embodiment of the present invention shown in FIG. 1 will subsequently be provided with the same reference numerals. Furthermore, a description of the setup and mode of functioning of the elements will be restricted to describing the differences to the infrared optics 11 shown in FIG. 1.

In contrast to the infrared optics 11 shown in FIG. 1, the infrared optics 51 comprise a first transparent cap 53a and a second transparent cap 53b which are arranged in a recess in a front wall of the casing 13. The infrared sensor 17 is attached to the back wall at a back wall opening 55 such that it completely covers the back wall opening 55 of the casing 13. The back wall opening 55 thus extends from the external surface of the back wall to the interior of the casing 13. A back wall mirror 57 is deposited on a surface of the back wall facing the interior of the casing. The back wall mirror 57 comprises a first region 57a and a second region 57b which are at least partly separated from each other by the opening 55. The first region 57a is opposite the first transparent cap 53a and the second region 57b is opposite the second transparent cap 53b.

The back wall mirror 57 is exemplarily embodied by a reflective layer deposited on a surface of the back wall of the casing 13 facing the interior of the casing, or the back wall 13 itself is made of a reflective material. The surface of the back wall mirror 57 has a double curvature or curvature relative to two mutually perpendicular axes, wherein the surface can be produced easily by pressing or casting the back wall material into a mold. An interior mirror 59 the surface of which also has a double curvature is arranged in the interior of the casing 13.

The infrared rays L1, L2 are incident on the interior of the casing 13 through the first transparent cap 53a and the second transparent cap 53b and impinge on the surface of the back wall mirror 57. From there, they are deflected to the surface of the interior mirror 59 and, from there, are influenced in their course or deflected such that they impinge on the infrared sensor 17 arranged over the back wall opening 55. The infrared optics shown in FIG. 3 thus comprise an arrangement like in a Schmidt telescope. At the same time, the first transparent cap 53a and the second transparent cap 53b, which may be embodied such that they also influence the course of the infrared rays L1, L2 penetrating same, form a protective window for the infrared optics 51. The caps 53a, 53b may advantageously be manufactured from silicon in a cheap manner and be patterned by means of processing steps known from microelectronics. Forming the caps 53a, 53b of plastic, like, for example, infrared-transparent polyimides, would also be conceivable, wherein the caps 53a, 53b could also be pressed. This results in a reduction in the manufacturing costs of the transparent caps 53a, 53b, thereby further reducing the production costs of the infrared optics 51.

Apart from the infrared optics 11, 31, 51 discussed in FIGS. 1-3, a cross-sectional view of infrared optics 71 in accordance with a fourth embodiment of the present invention is illustrated in FIG. 4. Same or equally shaped elements compared to the infrared optics 11 in accordance with a first embodiment of the present invention will subsequently be provided with the same reference numerals. In addition, a description of the setup and the mode of functioning of the elements in the infrared optics 71 in accordance with a fourth embodiment of the present invention will be limited to describing the differences to the infrared optics 11 shown in FIG. 1.

The infrared optics 71 comprise a window 73 which is mounted in a recess of the front side wall of the casing 13, and a mirror 75 deposited on a surface of the back side wall of the casing 13 facing the interior of the casing. A surface of the mirror region 75 is doubly curved or comprises a curvature relative to two mutually perpendicular axes, wherein the mirror region, similarly to the mirrors 19, 21, 57, 59, is produced by applying a reflective layer onto the back wall of the casing, or is formed by pressing or casting a reflective material, like, for example, aluminum, into a mold so that the casing 13 forms.

The surface of the mirror region 75 is shaped such that the infrared rays L1, L2 incident through the incident region or window 73 impinge on and are deflected or reflected by the surface of the mirror region 75 facing the interior of the casing such that they impinge on the sensitive region of the infrared sensor 17. The arrangement of the infrared optics 71 shown in FIG. 4 has a configuration which is referred to as the configuration according to Ritchey-Chretien.

After having shown above four embodiments of infrared optics in accordance with the present invention, a setup of a mold 80 for manufacturing the casing 13 for the infrared optics 11 will be discussed in FIG. 5. For explanatory reasons, the structure of the infrared optics 11 is outlined in FIG. 5, too. The mold 80 includes a first piece 81 and a second piece 83 which are mounted to each other or assembled such that a continuous form results. A first portion 85 extending into an interior region of the mold 80 projects from the first piece 81 and a second portion 87 extending into the interior of the mold 80 projects from the second piece 83. The projecting portions 85, 87 are arranged on the first piece 81 and the second piece 83 such that, when the first piece 81 and the second piece 83 are assembled, the side face of the first projecting portion 85 facing the second projecting portion 87 is arranged to be coplanar to the side face of the first projecting portion 85 facing the second projecting portion 87. Coplanar arrangement here means an arrangement of the two side faces such that they are arranged in a manner coplanar to each other within a tolerance of 2 mm or even 0.1 mm, i.e. a distance between the facing side faces of the portions 85, 87 is in a range of less than 2 mm.

Furthermore, in one embodiment of the mold 80, the surfaces or inner faces of the mold 80 are of a double curvature such that a doubly curved surface is produced or formed in a subsequent step of pressing or casting.

For manufacturing the infrared optics 11, a casting material, like, for example, plastic, is cast or pressed into the mold 80 serving as a tool such that the setup of the infrared optics 11 shown will form. Depending on the material, the surfaces serving as mirrors are metallized following pressing or casting. Metallization exemplarily takes place by means of vapor-depositing aluminum on the surface. If, however, the casing itself is made of a reflective material, like, for example, aluminum, this step will no longer be required.

After manufacturing the casing 13, the infrared sensor or image sensor or the transparent lid 15 or protective lid is mounted to the casing 13 and thus connected thereto. The infrared sensor 17 or the lid 15 may be mounted to the casing 13 in a cheap manner by means of molding-in, gluing or clicking-in.

In the infrared optics 11, 31, 51, 71, one or two mirrors 19, 21, 57, 59, 75 are arranged inside the casing 13. However, any numbers of mirrors serving to deflect the infrared rays L1, L2 may be used alternatively. The mirrors 19, 21, 57, 59, 75 have a doubly curved surface, wherein a ratio of the radii of curvature relative to mutually perpendicular axes may exemplarily be in a range from 0.1 to 10. Reflectivity of the mirrors 19, 21, 57, 59, 75 may exemplarily be in a range of greater than 0.9 or range of more than 90%. However, any ratios of the radii of curvature to each other and any reflectivity values would be conceivable in further embodiments of the mirrors. It would also be conceivable for the mirrors 19, 21, 57, 59, 75 to have a curvature of their surfaces relative to two different, not mutually perpendicular axes.

The mirrors 19, 21, 57, 59, 75 may be implemented such that they reflect infrared radiation of a wavelength in a range from 3 μm to 5 μm or 8 μm to 14 μm, which means that the reflectivity for infrared rays in this range of wavelengths has a value of greater than 0.9, wherein the reflectance value for a light ray of a wavelength of less than 0.7 μm may exemplarily also be in a range below 0.5. However, any characteristics of the mirrors 19, 21, 57, 59, 75 may be used alternatively in dependence on a wavelength of the infrared radiation or light.

A surface roughness of the mirrors 19, 21, 57, 59, 75 exemplarily is in a range from 0.3 μm to 3 μm or 0.125 times to 0.25 times a wavelength of a reflected infrared ray flux the wavelength of which exemplarily is in a range from 3 μm to 5 μm or a range from 8 μm to 14 μm, however, any mirror surface roughness values may be used alternatively. The mirrors 19, 21, 57, 59, 75 are manufactured such that they exemplarily are embodied to be integral with the casing 13 by forming the casing 13 of, for example, a reflective material, like aluminum, tin, glass or plastic, or vapor-depositing a reflective layer onto the inner face of the casing, wherein the reflective layer may exemplarily be embodied to be made of an aluminum material, a silver material or a glass material. However, any methods of manufacturing the mirrors 19, 21, 57, 59, 75 or the casing 13 comprising the mirrors mentioned which comprise a step of pressing or casting may be used alternatively. Methods of manufacturing the mirrors in which the mirrors are not deposited onto an inner face of a casing but are produced on any doubly curved surface by means of any step of depositing, such as gluing or vapor-depositing, are also conceivable. A reflective foil may, for example, be glued onto the doubly curved surface of a basic body, the reflective layer may be deposited by means of sputtering, or a reflective material may be deposited onto the doubly curved surface by means of galvanizing. It would even be conceivable to produce the mirror by means of depositing a dye onto the curved surface.

The lid 15, the transparent caps 53a, 53b or the window 73 is/are made of a translucent or infrared-transparent material which may exemplarily also differ from a material of the casing 13. Any materials of which the lid 15, the transparent caps 53a, 53b and the window 73 may be made are also conceivable. In the infrared optics 11, 31, the first side wall and the second side wall are arranged such that they are in parallel orientation to each other or such that the surfaces thereof enclose an angle in a range from 170 to 190°. The same also applies to an orientation of the front wall and the back wall in the infrared optics 51 and the front side wall and the back side wall in the infrared optics 71, respectively. However, in other infrared optics according to further embodiments of the present invention, any arrangements to one another of the walls mentioned are conceivable.

In the infrared optics 11, 31, the third side wall is arranged to be perpendicular to the first side wall or the second side wall or arranged such that the surfaces of the third side wall and the first side wall or the second side wall enclose an angle of 80° to 100°. However, any arrangements of the third side wall to the first side wall or the second side wall are conceivable in further embodiments of the infrared optics 11, 31.

In the infrared optics 11, 31, 51, 71, the lids 15, 33, 53a, 53b, 73 are mounted to the side wall of the casing 13 by means of molding-in, gluing or clicking-in, however, any methods of mounting the lid to the casing 13 are conceivable. Also, in further embodiments of the infrared optics 11, 31, 51, 71, the infrared sensor 17 may be mounted completely inside the casing 13, in a recess in the wall of the casing or to the side wall of the casing 13.

The mirrors 13, 19 in the infrared optics 11, 31 are arranged such that they are offset to each other, however, any arrangements of the mirrors 19, 21 may be used alternatively. In addition, the mirrors 19, 21 in the infrared optics 11, 31 are arranged such that they are arranged opposite the openings 13a, 13b and overlap same in a line of vision perpendicular to the side wall of the casing 13, however, any arrangements of the mirrors 19, 21 in the casing 13 may be used alternatively.

The casing 13 and/or the mirrors 19, 21, 57, 75 are exemplarily manufactured by pressing or casting a pressing material or a casting material into the mold 80. The mold 80 here includes the two parts or pieces 81, 83 which comprise the projecting portions 85, 87. However, any configurations of the pieces 81, 83 and any setups of the mold 80, like, for example, in one piece, are conceivable.

Embodying the windows and/or lids 15, 73 or caps 53a, 53b in the infrared optics 11, 31, 51, 71 such that they are able to influence the optical path of the infrared rays L1, L2 and may thus be used as correction plates would also be conceivable. The window may be produced of silicon, a plastic material or any material transparent for the infrared radiation. Here, the lid 15, 73 may also be embodied to be a lens, like, for example, a Fresnel lens.

In the casing 13, a region of the surface inside the casing may be patterned such that a reflectance for an infrared ray flux impinging on the patterned region on the surface is less than for an infrared ray flux impinging on the mirror 19, 21, 57, 59, 75, wherein grooves may exemplarily be arranged in the region of the patterned surface. Thus, a ratio of the reflectance of the surface in the patterned region and a reflectance in the region of the mirror 19, 21, 57, 59, 75 in an impinging infrared ray flux, the wavelength of which exemplarily is in a range of 3 μm to 5 μm or a range of 8 μm to 14 μm, may be between 0.1 and 0.7. However, any embodiments of the surface inside the casing 13 may be used alternatively.

1-5. (canceled)

6. The mirror of claim 5, wherein the doubly curved surface is adapted for reflecting an infrared ray flux incident on same the wavelength of which is in a range of 3 μm to 5 μm or a range of 8 μm to 14 μm such that a reflectance of an exiting infrared ray flux relative to the incident infrared ray flux is in a range of above 0.9.

7. The mirror of claim 6, wherein the doubly curved surface is adapted for reflecting a light flux incident on same the wavelength of which is in a range of less than 0.7 μm such that a reflectance of an exiting light flux relative to an incident light flux is in a range of below 0.5.

8-9. (canceled)

10. The casing of claim 14, wherein the doubly curved surface is coated with a reflective layer, a reflective foil is glued onto the doubly curved surface, or the pressing or casting material is a reflective material, so as to form the first mirror.

11-13. (canceled)

14. A casing made of pressing or casting material and comprising a first opening and a second opening, which is cast or pressed such that a first mirror comprising a doubly curved surface is arranged inside the casing such that a ray entering the first opening is deflected by the first mirror such that the ray exits the casing in the second opening.

15. The casing of claim 10, wherein a region of a surface inside the casing is patterned such that a reflectance for an infrared ray flux impinging on the surface in the patterned region is smaller than for an infrared ray flux impinging on the first mirror.

16. (canceled)

17. The casing of claim 10, wherein a transparent lid for closing the first opening embodied to be made of a material different from the material of the casing is arranged.

18. The casing of claim 10, comprising a rectangular cross-section, and wherein the first opening and the second opening are arranged on surfaces of the casing facing away from each other.

19. (canceled)

20. The casing of claim 10, wherein the casting material is cast or pressed such that the first mirror and a second mirror comprising a doubly curved surface are arranged inside the casing such that a ray entering the first opening is deflected by the first mirror onto the second mirror, and subsequently from the second mirror such that the ray exits the casing in the second opening.

21. The casing of claim 20, wherein the first mirror and the second mirror are arranged offset to each other such that the mirrors do not overlap as seen along a predetermined line of vision, and the first mirror is located opposite the first opening, and the second mirror is located opposite the second opening.

21. The casing of claim 20, wherein the first mirror and the second mirror are arranged offset to each other such that the mirrors do not overlap as seen along a predetermined line of vision, and the first mirror is located opposite the first opening, and the second mirror is located opposite a third opening within the casing which exists within the casing in addition to the first opening and the second opening.

22-25. (canceled)

26. An infrared device comprising an infrared sensor or infrared source, comprising a casing made of pressing or casting material and comprising a first opening and a second opening, which is cast or pressed such that a first mirror comprising a doubly curved surface is arranged inside the casing such that a ray entering the first opening is deflected by the first mirror such that the ray exits the casing in the second opening.

27. The infrared device of claim 26, comprising the infrared sensor mounted to the casing such that the sensor completely covers the second opening casing so as to shut the interior of the casing at the second opening.

28-34. (canceled)

35. A method of manufacturing a casing comprising a first opening and a second opening and a mirror which comprises a doubly curved surface and is arranged inside the casing such that a ray entering the first opening is deflected by the first mirror such that the ray exits the casing in the second opening, comprising the step of:
pressing or casting a pressing or casting material into a mold such that the doubly curved surface forms inside the casing.

36-38. (canceled)

39. The method of claim 35, wherein the mold is embodied to be made of two pieces, which comprise, at inner faces of same, one projecting portion, respectively, comprising a doubly curved surface, and which are joined to each other, during pressing or casting, such that the projecting portions each extend into the interior of the mold, while portions of a side face of the projecting portions are arranged in a mutually coplanar manner, so that after pressing or casting, the first mirror and a second mirror comprising doubly curved surfaces are arranged inside the casing such that a ray entering the first opening is deflected by the first mirror onto the second mirror, and subsequently from the second mirror such that the ray exits the casing in the second opening, and that
the mirrors do not overlap as seen along a predetermined line of vision, and the first mirror is located opposite the first opening, and the second mirror is located opposite the second opening, or
the mirrors do not overlap as seen along a predetermined line of vision, and the first mirror is located opposite the first opening, and the second mirror is located opposite a third opening within the casing which exists within the casing in addition to the first opening and the second opening.

40. The method of claim 35, wherein the step of pressing or casting is followed by a step of molding-in, gluing-on or clicking-in an infrared sensor or a lid to a side wall of the casing.
